(19) United States
(12) Patent Application Publication
(10) Pub. No.: US 2011/0316702 A1
(43) Pub. Date: Dec. 29, 2011

(54) ELECTRONIC DEVICE WITH AUTOMATIC NOTIFICATION FUNCTION FOR PERSONAL EMERGENCY AND METHOD THEREOF

(75) Inventors: PING-YANG CHUANG, Tu-Cheng (TW); YING-CHUAN YU, Tu-Cheng (TW)

(73) Assignee: HON HAI PRECISION INDUSTRY CO., LTD., Tu-Cheng (TW)

(21) Appl. No.: 13/032,645

(22) Filed: Feb. 23, 2011

(30) Foreign Application Priority Data
Jun. 25, 2010 (TW) 99120971
Nov. 25, 2010 (TW) 99140744

(51) Int. Cl. G08B 23/00

(52) U.S. Cl. 340/573.1

(57) ABSTRACT

An electronic device having an automatic notification function for a personal emergency is provided. The electronic device includes a positioning unit, a storage unit, a sensor unit, a processing unit, and a communications unit. The positioning unit provides location information of the electronic device using longitude and latitude. The storage unit stores an emergency message, communication information, and the location information of the electronic device. The sensor unit senses whether an acceleration according to certain predetermined falling parameters is experienced by the electronic device. The processing unit acquires the location information of the electronic device and the emergency message from the storage unit, and edits the emergency message with the acquired location information to generate a notification when the falling parameters of the electronic device occur. The communications unit delivers the notification according the communication information.

### BACKGROUND

1. Related Applications

The subject matter disclosed in this application is related to subject matters disclosed in a copending application entitled, “ELECTRONIC DEVICE WITH AUTOMATIC NOTIFICATION FUNCTION FOR PERSONAL EMERGENCY AND METHOD THEREOF”, filed ______ (Atty. Docket No. US36340), and assigned to the same assignee as named herein.

2. Technical Field

The present disclosure relates to electronic devices and, particularly, to an electronic device that can automatically notify emergency responders in case of a personal emergency and a method thereof.

3. Description of Related Art

In general, time to notify for rescue is critical in case of emergencies, for instance, when mountain climbers are injured in accidents. A period of time known as the golden hour for rescue can quickly slip away if needed help is not received.

### BRIEF DESCRIPTION OF THE DRAWINGS

FIG. 1 is a block diagram of a hardware infrastructure of a system with an automatic notification function for a personal emergency, in accordance with an exemplary embodiment.

FIG. 2 is a block diagram of a hardware infrastructure of a system with an automatic notification function for a personal emergency, in accordance with another embodiment.

FIG. 3 is a flowchart of a method having an automatic notification function for a personal emergency implemented by the system of FIG. 1, in accordance with an exemplary embodiment.

### DETAILED DESCRIPTION

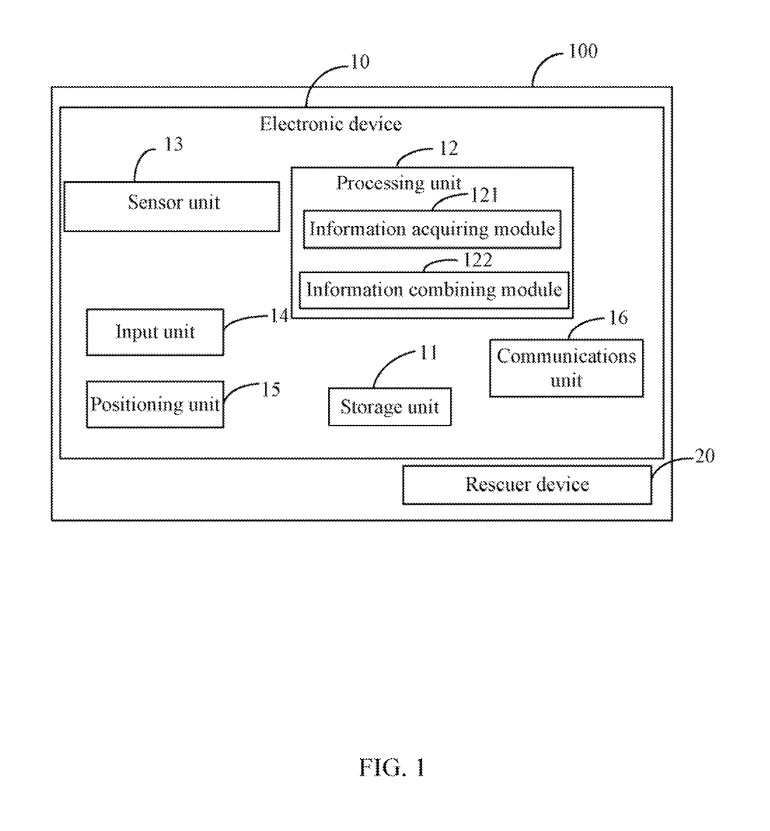

Referring to FIG. 1, a system 100 with an automatic notification function for a personal emergency is provided. The system 100 includes an electronic device 10 and at least one rescuer device 20. The device 10 is for automatically collecting data to generate a notification when climbers become a victim of a climbing accident, and delivering the notification to the rescuer device 20 for obtaining help. The device 10 may be a wearable electronic device, portable electronic device, or a device that can be mounted on a motor vehicle or work station. The rescuer device 20 may be an electronic device such as, a mobile phone, or a PDA, which can receive any messages sent by the device 10.

The device 10 includes a storage unit 11, an input unit 14, a processing unit 12, a sensor unit 13, a positioning unit 15, and a communications unit 16. The input unit 14 may be used to call up and edit (personalize) a predetermined emergency message template to form an emergency message that can be accessed when the bearer of the device 10 is apparently involved in a climbing accident. The communications unit 16 can transmit the emergency message to the rescuer device 20 according to a user input and pre-programmed communication information of the device 20, such as the phone number of the device 20 and/or email address of an account monitored by the device 20 upon occurrence of a climbing accident. The positioning unit 15 is for providing location information of the device 10 using longitude and latitude. In one embodiment, the positioning unit 15 may be a global positioning system (GPS) or an assisted global positioning system (AGPS). In other embodiments, the positioning unit 15 may be some other positioning system which can provide the longitude and latitude of the location information of the device 10. The storage unit 11 is for storing the emergency message, the communication information of the rescuer device 20 and the location information of the device 10.

The sensor unit 13 is for sensing whether an acceleration has occurred according to certain predetermined falling parameters experienced by the device 10. The falling parameters may be predetermined distance, time or velocity, and so on. In one embodiment, the sensor unit 13 may be a three axis acceleration sensor or a two axis acceleration sensor, etc.

The processing unit 12 includes an information acquiring module 121 and an information combining module 122. The information acquiring module 121 is for acquiring the location information of the device 10 and the emergency message from the storage unit 11 when the acceleration has occurred according to the certain predetermined falling parameters experienced by the device 10. In one embodiment, the acceleration is a gravitational acceleration. The information combining module 122 is for generating the notification by editing the emergency message with the acquired location information. For example, the content of the notification may be: “This is John, I have been in a climbing accident at 113°46′ and 22°27′ please send help!” In one embodiment, the format of the notification may be text, video, or voice, etc. The notification may, in addition to or instead of longitude and latitude, include a nearby landmark where the accident has occurred. The communications unit 16 delivers the notification to other rescuer devices 20 by using a peer-to-peer technology.

The rescuer device 20 is for receiving the notification from the device 10, and allowing rescuer personnel to determine the position of the user of the device 10 according to the content of the notification.

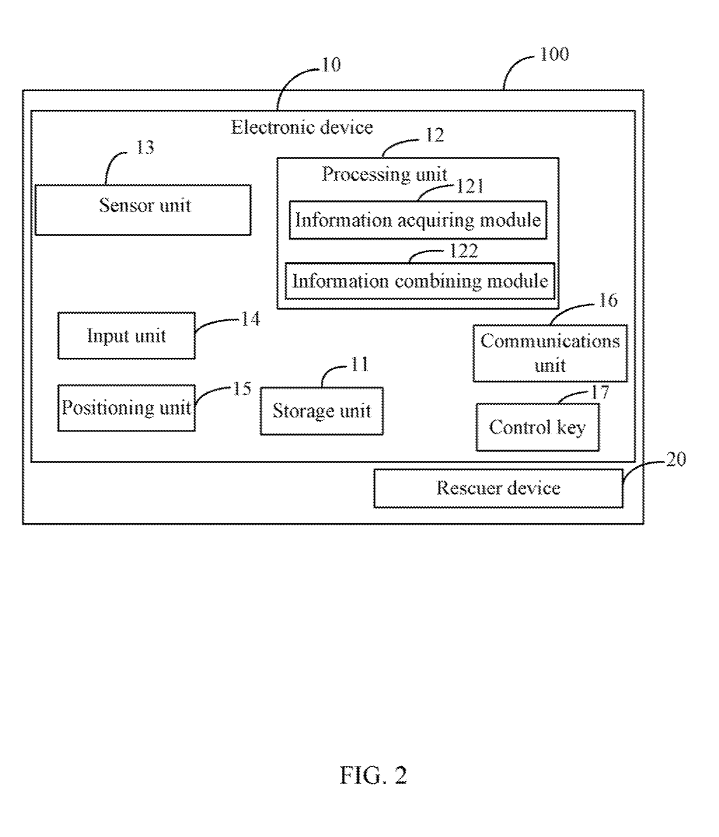

As shown in FIG. 2, in a second embodiment, the device 10 further includes a control key 17 which is used for generating a control instruction in response to the user input. The processing unit 12 edits the emergency message with the acquired the location information of the device 10 to generate the notification, and controls the communications unit 16 to deliver the notification to the rescuer device 20 in response to the control instruction from the control key 17.

In a third embodiment, the sensor unit 13 is further used for detecting whether a variation of the acceleration of the device 10 is regular during a predetermined period when the falling parameters of the device 10 instantly occur. The processing unit 12 edits the emergency message with the acquired the location information of the device 10 to generate the notification, and controls the communications unit 16 to deliver the notification to the rescuer device 20 when an irregular variation of the device 10 occurs during a predetermined period.

In one embodiment, after the falling parameters of the device 10 change instantly, the sensor unit 13 senses other irregular falling parameters of the device 10 during the predetermined period, this means that the variation of the acceleration of the device 10 is irregular. Otherwise, after the falling parameters of the device 10 change instantly, the sensor unit 13 senses another regular falling parameter of the device 10 during the predetermined period; this means that the variation of the acceleration of the device 10 is regular.

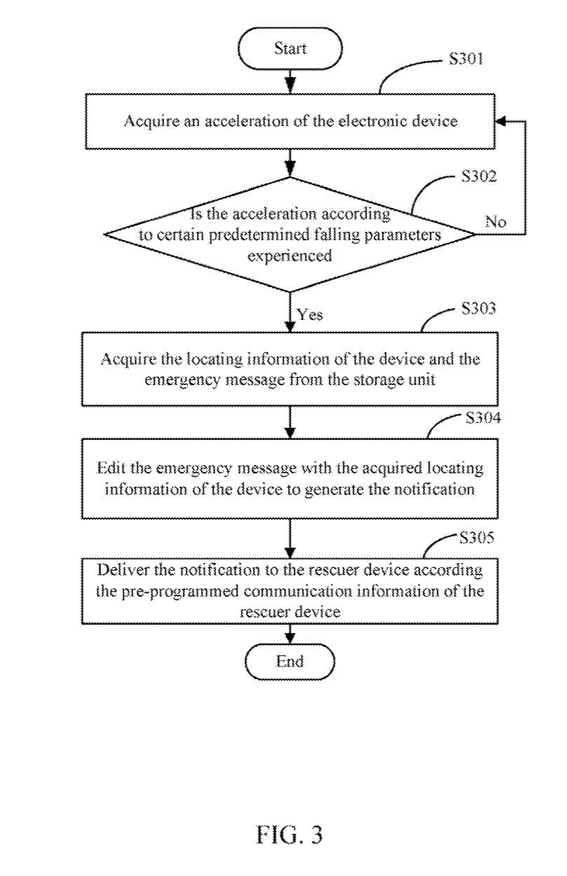

FIG. 3 is a flowchart of a method having an automatic notification function for a personal emergency implemented by the system in accordance with an exemplary embodiment.

In step S301, the sensor unit 13 acquires the acceleration of the device 10.

In step S302, the sensor unit 13 senses whether the acceleration according to the certain predetermined falling parameters are experienced by the device 10, if yes, the procedure goes to S303, if no, the procedure goes to S301.

In step S303, the information acquiring module 121 acquires the location information of the device 10 and the emergency message from the storage unit 11.

In step S304, the information combining module 122 edits the emergency message with the acquired location information of the device 10 to generate the notification.

In step S305, the communications unit 16 delivers the notification to the rescuer device 20 according the pre-programmed communication information of the rescuer device 20.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device having an automatic notification function for a personal emergency, comprising:
a positioning unit for providing location information of the electronic device using longitude and latitude;
a storage unit for storing an emergency message, communication information, and the location information of the electronic device;
a sensor unit for sensing whether an acceleration according to certain predetermined falling parameters is experienced by the electronic device;
a processing unit for acquiring the location information of the electronic device and the emergency message from the storage unit, and editing the emergency message with the acquired location information to generate a notification when the falling parameters of the electronic device occur; and
a communications unit for delivering the notification to a rescuer device according the communication information.

2. The electronic device as described in claim 1, wherein the acceleration is a gravitational acceleration.

3. The electronic device as described in claim 1, wherein the sensor unit is a three axis acceleration sensor.

4. The electronic device as described in claim 1, wherein the sensor unit is a two axis acceleration sensor.

5. The electronic device as described in claim 1, further comprising a control key which is used for generating a control instruction in response to an user input, wherein the processing unit acquires the location information of the electronic device and the emergency message from the storage unit, edits the emergency message with the acquired location information of the device to generate the notification, and controls the communications unit to deliver the notification to the rescuer device in response to the control instruction from the control key.

6. The electronic device as described in claim 1, wherein the positioning unit is a global positioning system or an assisted global positioning system.

7. The electronic device as described in claim 1, wherein the positioning unit is a combination of a global positioning system and an assisted global positioning system.

8. The electronic device as described in claim 1, wherein the communications unit delivers the notification to the rescuer device by using a peer-to-peer technology.

9. The electronic device as described in claim 1, wherein the sensor unit is further for detecting whether a variation of the acceleration of the electronic device is regular during a predetermined period after the falling parameters of the electronic device instantly occurs according to certain predetermined falling parameters experienced; the processing unit edits the emergency message with the acquired the location information of the electronic device to generate the notification, and controls the communications unit to deliver the notification to the rescuer device when an irregular variation of the acceleration has occurred during a predetermined period.

10. The electronic device as described in claim 1, further comprising:
an input unit used for editing the emergency message.

11. An electronic device having an automatic notification function for a personal emergency, comprising:
a positioning unit for providing location information of the electronic device using longitude and latitude;
a storage unit for storing an emergency message, communication information, and the location information of the electronic device;
a control key for generating a control instruction in response to an user input;
a processing unit for acquiring the location information of the electronic device and the emergency message from the storage unit, editing the emergency message with the acquired location information of the device to generate the notification; and
a communications unit for delivering the notification according the communication information in response to the control instruction.

12. A method having an automatic notification function for a personal emergency implemented by an electronic device, wherein the electronic device comprises a positioning unit and a storage unit, the positioning unit is for providing location information of the electronic device using longitude and latitude, and the storage unit is for storing an emergency message, communication information, and the location information of the electronic device, the method comprising:
sensing whether an acceleration according to certain predetermined falling parameters is experienced by the electronic device;
acquiring the location information of the electronic device and the emergency message from the storage unit, and editing the emergency message with the acquired location information to generate a notification when the falling parameters of the electronic device occur; and
delivering the notification according the communication information.

13. A method having an automatic notification function for a personal emergency implemented by an electronic device, wherein the electronic device comprises a positioning unit and a storage unit, the positioning unit is for providing location information of the electronic device using longitude and latitude, and the storage unit is for storing an emergency message, communication information, and the location information of the electronic device, the method comprising:
generating a control instruction in response to an user input;
acquiring the location information of the electronic device and the emergency message from the storage unit, editing the emergency message with the acquired location information of the electronic device to generate the notification; and
delivering the notification according the communication information in response to the control instruction.
